(19) United States
(12) Patent Application Publication
(10) Pub. No.: US 2020/0071859 A1
(43) Pub. Date: Mar. 5, 2020

(54) STABILIZED REINFORCING TEXTILE FABRIC AND PRODUCTION METHOD THEREOF

(71) Applicant: KORDSA TEKNIK TEKSTIL A.S., Izmit (TR)

(72) Inventors: Deniz KORKMAZ, Izmit (TR); Elcin CAKAL SARAC, Izmit (TR); Egemen BILGE, Izmit (TR)

(73) Assignee: KORDSA TEKNIK TEKSTIL A.S., Izmit (TR)

(21) Appl. No.: 16/468,749

(22) PCT Filed: Dec. 11, 2017
(86) PCT No.: PCT/TR2017/050641

§ 371 Date: Jun. 12, 2019

(30) Foreign Application Priority Data
Dec. 12, 2016 (TR) 2016/18339

(51) Int. Cl. D03D 15/00; B29C 65/62; B29C 65/72; C08J 5/04

(52) U.S. Cl. CPC D03D 15/0027; B29C 65/62; B29C 65/72; C08J 5/043; D10B 2505/02; C08J 5/044; C08J 5/048; D10B 2101/12; D10B 2401/041; C08J 5/042

(57) ABSTRACT

A stabilized reinforcing textile fabric including at least one uni-directional reinforcing yarn (A) layer and a plurality of stitching yarns. The plurality of stitching yarns are meltable thermoplastic yarns (B) functioning as a stabilizing resin. The at least one uni-directional reinforcing yarn is includes a carbon fiber, a glass fiber, an aramid fiber, and a natural fiber, or a combination thereof. The meltable thermoplastic stitching yarns include polyamides, polyolefins, polyphthalamides, polyphenylene sulfide, polysulfone, polyether sulfone, polyarylene sulfide, fluoropolymer, polyacetal, polycarbonate, polyether ketone, polyether ether ketone, polyimide, polyether imide, polyarylene ether sulfone, styrenic polymer, polyesters or a combination thereof.

### CROSS REFERENCE TO THE RELATED APPLICATIONS

This application is the national phase entry of International Application No. PCT/TR2017/050641, filed on Dec. 11, 2017, which is based upon and claims priority to Turkish Patent Application No. 2016/18339, filed on Dec. 12, 2016, the entire contents of which are incorporated herein by reference.

### TECHNICAL FIELD

The present invention relates to a production method which is developed in order to be used as structural and visual material in all industrial fields, mainly aviation, defense industry, medical, marine and automotive, and which enables the stitched fabric formed with a yarn that is manufactured from reinforcing fiber to be stabilized with meltable thermoplastic stitching yarn.

### BACKGROUND

The composites are divided into two main categories, namely thermoset and thermoplastic. The thermoset composites are structures comprised of thermoset resin impregnated yarns manufactured from reinforcing fibers. The thermoplastic composites are structures comprised of thermoplastic resin impregnated yarns manufactured from reinforcing fibers. The composites are very popular today due to their lightweight, reducing emission values, and resistance against corrosion properties.

Today, the resin used in stabilizing textiles comprising reinforcing fiber used in composite sector is applied as liquid or powder. The bulk textile product which is obtained is then transformed into composite material which is the final product which production methods such as thermal and/or pressure forming.

In order to stabilize the textiles which are developed to produce thermoset and thermoplastic composite, stitching yarns such as polyamides (PA) (polyamide 6 (PA6), polyamide 6,6 (PA66), polyphthalamide (PPA)), polyphenylene sulfide (PPS), polysulfone (PSU) polyarylenethersulfone, polyolefines (polyethylene (PE), polypropylene (PP) etc.), polyimide (PI), polyesters, preferably such as polyethylene terephthalate (PET) or polybutylene terephthalate (PBT), polyether ether ketone (PEEK) can be used.

In stabilizing process, powder and liquid resin can be applied with manual or automatic methods on the textile comprising reinforcing fiber. Especially, the powder application causes situations such as homogenization problem in distributing resin, difficulty in using optimum raw material, high amount of waste occurring during production, and variance in strength value of the produced composite material.

The production method used in stabilizing the textiles comprising reinforcing fiber can be performed with discontinuous process or continuous process. In both discontinuous and continuous methods, even in case of feeding the powder and liquid resin is automatic, the resin/reinforcing fiber ratio cannot be applied in the desired accuracy since the amount of resin to be used is quite low. Variations occur in the resin amounts used in unit area.

### SUMMARY

The objective of the present invention is to provide a production method which enables resin used in stabilization application of the stitched fabrics obtained from reinforcing fiber containing yarns to better impregnate into the structure, that is to better stabilize the reinforcing yarns relative to the conventional applications. In the application, the resin is applied in meltable thermoplastic stitching yarn form. By means of stabilization, the spacing between the yarns comprising reinforcing yarn in the structure becomes more stable and controllable.

Another objective of the present invention is to enable the reinforcing structure to provide ease of use during composite production and the composite material to have more homogenous strength values. Complex composite parts can easily be manufactured with the dry fabric obtained by means of this production method.

### BRIEF DESCRIPTION OF THE DRAWINGS

The examples of the “Stabilized reinforcing textile fabric” fulfilling the objective of the present invention are illustrated in the accompanying figures, in which;

FIG. 1A shows a side view of an embodiment of a textile material which is subjected to the stabilized reinforcing textile production method and wherein the type of the stitched fabric is triaxial;

FIG. 1B shows a top view of the embodiment of the textile material which is subjected to the stabilized reinforcing textile production method and wherein the type of the stitched fabric is triaxial;

FIG. 2A shows a side view of another embodiment of a textile material which is subjected to the stabilized reinforcing textile production method and wherein the type of the stitched fabric is uni-directional;

FIG. 2B shows a top view of the another embodiment of the textile material which is subjected to the stabilized reinforcing textile production method and wherein the type of the stitched fabric is uni-directional;

FIG. 3A shows a side view of another embodiment of a textile material which is subjected to the stabilized reinforcing textile production method and wherein the type of the stitched fabric is biaxial; and

FIG. 3B shows another a top embodiment of the textile material which is subjected to the stabilized reinforcing textile production method and wherein the type of the stitched fabric is biaxial.

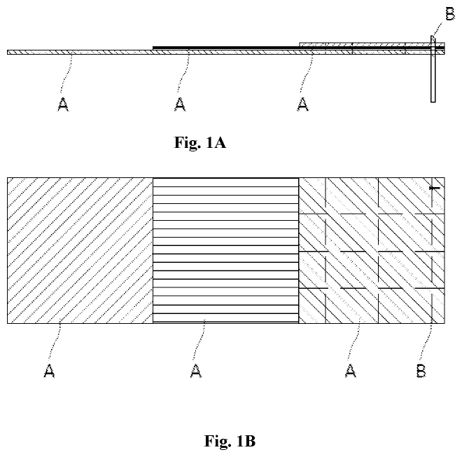

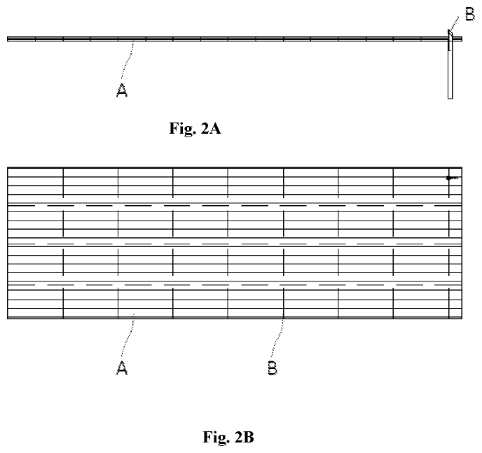

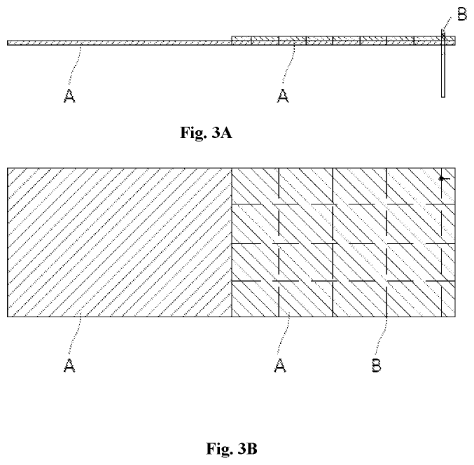

The components given in the figures are assigned reference numerals as follows:

A. Reinforcing yarn

B. Meltable thermoplastic stitching yarn

### DETAILED DESCRIPTION OF THE EMBODIMENTS

A stabilized reinforcing yarn production method comprises the steps of
i) Obtaining stitched fabric by using thermoplastic stitching yarn in certain distances depending on the used reinforcing yarn and resin (thermoplastic stitching yarn) ratio,
ii) Impregnating the stitching yarn used in certain distances in order to adjust the ratio of the thermoplastic yarn in the textile material into the said structure by means of melting or softening.

The inventive reinforcing textile stabilization method; which is developed for composite part production, and enables the resin in form of a thermoplastic yarn used for stabilizing the stitched fabric comprising reinforcing yarn to be impregnated into the structure homogenously and deeply; comprises the steps of
Obtaining by using thermoplastic stitching yarn in certain distances depending on the reinforcing yarn and resin ratio used in production of stitched fabric,
Increasing the temperature of the stitched fabric above softening or melting point of the thermoplastic yarn,
Applying pressure (0-100 bar) on the stitched fabric at this temperature,
Applying pre-tensioning (0-5 g/tex) on the stitched fabric at this temperature,
Enabling the thermoplastic resin in yarn form, in other words the stitching yarn, to be impregnated into the structure by melting,
Applying temperature for a time in range of 0.01-60 minutes,
Obtaining the ready to use final product by cooling until it reaches a temperature below glass transition temperature (T_{g}) of the resin without pressure or under pressure.

For example, during the process of increasing the temperature of the stitched fabric above softening or melting point of the thermoplastic yarn, it is enabled that the thermoplastic yarn used as resin is impregnated between the fibers of the reinforcing yarn by melting the thermoplastic yarn via hot roll, press or infrared heater. If the dry fabric stabilized with the thermoplastic stitching yarn will be used for thermoplastic composite production, it is preferred that the thermoplastic yarn to be used for stabilization is same as the resin used as matrix. In use for producing thermoset composite, the thermoplastic stitching yarn used for stabilization is coated with suitable sizing material. Therefore, the thermoset resin used as matrix is compatible with the thermoplastic yarn. Epoxy resins, phenol resins, cyanate ester resins, vinyl ester resins, unsaturated polyester resins, and the resins obtained by modifying them can be given as example for thermoset resins to be used as matrix.

In the said invention, the stitching yarns used in the stitching process is manufactured from material selected from a group comprising polyamides (such as polyamide 6 (PA6), polyamide 6,6 (PA66), polyphthalamide (PPA)), polyphenylene sulfide (PPS), polysulfone (PSU) (such as polyethersulfone (PES), polyarylenethersulfone), polyarylenesulfide, fluoropolymer, polyacetal, polycarbonate, styrenic polymer, polyolefins (such as polyethylene (PE), polypropylene (PP)), polyimide (PI), polyetherimide, polyesters preferably polyethylene terephthalate (PET) or polybutylene terephthalate (PBT), polyether ether ketone (PEEK), polyether ketone (PEK), or combinations thereof.

In the said invention, the weight of the meltable thermoplastic stitching yarn used for stabilization can change between 10 to 2000 dtex.

In the said invention, as reinforcing yarn (A) used in producing the stitched yarn, a yarn produced from a material selected from the group comprising glass fiber, carbon fiber, aramid fiber, natural fiber, or a combination thereof is used.

The term “stitched fabric” used in the invention is defined as a system comprised of one or more than one unidirectional fiber layers, and formed by holding these layers together by stitching with a stitching yarn manufactured from thermoplastic polymer. When the angles of the unidirectional layers forming the stitched fabrics, the fabrics can be unidirectional, biaxial, triaxial or multiaxial.

The term “dtex” used in the invention is the weight in grams per 10000 meters yarn.

In the inventive production method, the resin used for stabilization being in form of yarn manufactured from thermoplastic fiber enables the amount of resin/reinforcing fiber ratio in the stitched fabric to be adjusted easily.

The present invention comprises application of 0-100 bars, preferably in range of 0-40, of pressure on the resin in step of heating of the resin.

In the present invention, the cooling of the resin penetrating into the stitched fabric is carried out under 0-100 bars of pressure, preferably in range of 1-40 bars of pressure.

In the said invention, the weight of the thermoplastic resin used for stabilization is maximum 10% of the weight of the yarn manufactured from reinforcing fiber.

In the production method used in stabilizing the textiles comprising reinforcing fiber, discontinuous or continuous methods can be used. The main principle used in both methods is to apply the resin used for stabilizing the stitched fabric produced with yarn manufactured from reinforcing yarn in thermoplastic yarn form, and to apply pressure (0-100 bar) at a temperature above softening or melting point, and to enable the resin to impregnate into the reinforcing yarns in this way. Cooling process is applied after temperature and pressure is applied for a determined time between 0.01 minutes and 60 minutes. Cooling process can be applied without pressure or under pressure (0-100 bar) depending on the structure of the polymer. The cooling temperature is below the glass transition temperature (T_{g}) of the resin. The temperature range that can be used in cooling process is between 25° C. and 200° C. The applications known in the state of the art cannot provide the resin to be homogenously impregnated into the fibers and cannot provide precise resin distribution. On the other hand, in the inventive method, since the resin is used in yarn form, the resin/reinforcing fiber ratio can be accurately adjusted. In summary, with the newly developed method, resin homogenization in amount is provided before starting the process.

In another preferred embodiment of the invention, the yarns manufactured from reinforcing fiber (glass, carbon, aramid, natural fiber, etc.) used in dry fabric is applied in single layer or different layers of the fabric, and thus it is possible to use the hybrid structure obtained in this way. Two or more kinds of reinforcing yarns (A) can be used in hybrid fabrics. For example, carbon and glass reinforcing yarn and meltable thermoplastic stitching yarn (B) can also be used in the same stitched fabric.

Within the scope of the inventive method, dry fabric comprising reinforcing yarn (A) and meltable thermoplastic stitching yarn (B) is manufactured with the multiaxial textiles production machine which is being currently used. During production, stabilized textile material can be produced in the same process by using infrared heater right after the stitching process. Therefore, there is no extra process step required during powder or liquid coating applied for conventional thermoplastic stabilization production, and thus the production is carried out faster. By means of the said method, complex composite parts can easily be manufactured via easy lay-up.

In the inventive production method, stitched fabrics comprising reinforcing yarn (A) and meltable thermoplastic stitching yarn (B) can be processed in more accurate resin amounts, and they can be processed more easily.

By means of the stitched fabric kinds that are designed differently, textiles with different mechanical properties can be obtained. By this means the composite structure can be varied compatible with the field of use of the end user. Furthermore, the stitched fabrics are suitable for being used in wide range of application fields since it allows placing the reinforcing yarn in different axes.

What is claimed is:

1. A stabilized reinforcing textile fabric comprising: at least one uni-directional reinforcing yarn layer and a plurality of stitching yarns; wherein, the plurality of stitching yarns are meltable thermoplastic yarns functioning as a stabilizing resin.

2. The stabilized reinforcing textile fabric according to claim 1, wherein, the at least one uni-directional reinforcing yarn is comprised of a carbon fiber, a glass fiber, an aramid fiber, and a natural fiber, or a combination thereof.

3. The stabilized reinforcing textile fabric according to claim 1, the meltable thermoplastic stitching yarns are comprised of polyamides, polyolefins, polyphthalamides, polyphenylene sulfide, polysulfone, polyether sulfone, polyarylene sulfide, fluoropolymer, polyacetal, polycarbonate, polyether ketone, polyether ether ketone, polyimide, polyether imide, polyarylene ether sulfone, styrenic polymer, polyesters or a combination thereof.

4. The stabilized reinforcing textile fabric according to claim 1, wherein, a ratio of the meltable thermoplastic stitching yarns to the at least one uni-directional reinforcing yarn is maximum 10% by weight.

5. A method of producing a stabilized reinforcing yarn, comprising:
i) obtaining a stitched textile fabric by stitching at least one uni-directional reinforcing yarn layer with a meltable thermoplastic stitching yarn;
ii) impregnating the stitched textile fabric into the stitched textile fabric by melting or softening the meltable thermoplastic stitching yarn by heating the stitched textile fabric at least to a melting or softening temperature of the meltable thermoplastic stitching yarn.

6. The method according to claim 5, wherein, the at least one uni-directional reinforcing yarn is comprised of a carbon fiber, a glass fiber, an aramid fiber, a natural fiber, or a combination thereof.

7. The method according to claim 5, wherein, the meltable thermoplastic stitching yarn is comprised of polyamides, polyolefins, polyphthalamides, polyphenylene sulfide, polysulfone, polyether sulfone, polyarylene sulfide, fluoropolymer, polyacetal, polycarbonate, polyether ketone, polyether ether ketone, polyimide, polyether imide, polyarylene ether sulfone, styrenic polymer, polyesters or a combination thereof.

8. The method according to claim 5, wherein, the meltable thermoplastic stitching yarn is stitched in certain distances of the textile fabric depending on a ratio of the meltable thermoplastic stitching yarn to the stabilized reinforcing yarn.

9. The method according to claim 5, wherein, a pressure in a range of 0-100 bars is applied on the stitched textile fabric in a stage of melting or softening the meltable thermoplastic stitching yarn.

10. The method according claim 5, wherein, a temperature in a range of 0.1-60 minutes is applied on the stitched textile fabric in a stage of melting or softening the meltable thermoplastic stitching yarn.

11. The method according to claim 5, wherein, the stitched textile fabric impregnated with the meltable thermoplastic stitching yarn is cooled to a temperature below a glass transition temperature of the meltable thermoplastic stitching yarn after the step of impregnating the meltable thermoplastic stitching yarn into the stitched textile fabric.

12. The method according to claim 6, wherein, the meltable thermoplastic stitching yarn is stitched in certain distances of the textile fabric depending on a ratio of the meltable thermoplastic stitching yarn to the stabilized reinforcing yarn.

13. The method according to claim 7, wherein, the meltable thermoplastic stitching yarn is stitched in certain distances of the textile fabric depending on a ratio of the meltable thermoplastic stitching yarn to the stabilized reinforcing yarn.

14. The method according to claim 6, wherein, a pressure in a range of 0-100 bars is applied on the stitched textile fabric in a stage of melting or softening the meltable thermoplastic stitching yarn.

15. The method according to claim 7, wherein, a pressure in a range of 0-100 bars is applied on the stitched textile fabric in a stage of melting or softening the meltable thermoplastic stitching yarn.

16. The method according claim 6, wherein, a temperature in a range of 0.1-60 minutes is applied on the stitched textile fabric in a stage of melting or softening the meltable thermoplastic stitching yarn.

17. The method according claim 7, wherein, a temperature in a range of 0.1-60 minutes is applied on the stitched textile fabric in a stage of melting or softening the meltable thermoplastic stitching yarn.

18. The method according to claim 6, wherein, the stitched textile fabric impregnated with the meltable thermoplastic stitching yarn is cooled to a temperature below a glass transition temperature of the meltable thermoplastic stitching yarn after the step of impregnating the meltable thermoplastic stitching yarn into the stitched textile fabric.

19. The method according to claim 7, wherein, the stitched textile fabric impregnated with the meltable thermoplastic stitching yarn is cooled to a temperature below a glass transition temperature of the meltable thermoplastic stitching yarn after the step of impregnating the meltable thermoplastic stitching yarn into the stitched textile fabric.

20. The method according to claim 8, wherein, the stitched textile fabric impregnated with the meltable thermoplastic stitching yarn is cooled to a temperature below a glass transition temperature of the meltable thermoplastic stitching yarn after the step of impregnating the meltable thermoplastic stitching yarn into the stitched textile fabric.
